(19) United States
(12) Patent Application Publication
(10) Pub. No.: US 2008/0039261 A1
(43) Pub. Date: Feb. 14, 2008

(54) POWER DELIVERY SYSTEM OF HYBRID VEHICLE

(76) Inventors: Sung Tae CHO, Gunpo-si (KR); Jang Moo LEE, Seongnam-si (KR); Nam Wook KIM, Seoul (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/834,884

(22) Filed: Aug. 7, 2007

(30) Foreign Application Priority Data
Aug. 8, 2006 (KR) 10-2006-0074774

(51) Int. Cl. F16H 3/62

(52) U.S. Cl. 475/5

(57) ABSTRACT

A power delivery system of a hybrid vehicle includes: a planetary gear part disposed including a first planetary gear, a second planetary gear, and a third planetary gear; a driving motor/generator part including a first motor/generator connected to the third planetary gear such that a power delivery can be performed therebetween, and a second motor/generator configured to deliver power to a driving shaft via the second planetary gear and supporting an engine in a starting state so as to operate the driving shaft; a clutch part connected to the planetary gear part such that the hybrid vehicle can drive by changing the operation mode at at least a critical mechanical point wherein the mechanical power of the driving motor/generator part is zero; and a controller controlling operations of the driving motor/generator part and the clutch part.

### CROSS-REFERENCE TO RELATED APPLICATION

This application claims priority to and the benefit of Korean Patent Application No. 10-2006-0074774 filed in the Korean Intellectual Property Office on Aug. 8, 2006, the entire contents of which are incorporated herein by reference.

### BACKGROUND OF THE INVENTION

(a) Field of the Invention

The present invention relates to a power delivery system of a hybrid vehicle and, more particularly to a system that can be driven by changing an operation mode of a transmission at at least a critical mechanical point.

(b) Description of the Related Art

A hybrid vehicle is a vehicle that is driven by two power sources, for example, a gasoline engine and an electric motor/generator, a hydrogen engine and a fuel cell, a natural gas engine and a gasoline engine, a diesel engine and an electric motor/generator, of the like. Generally, a hybrid vehicle today uses a gasoline engine and an electric motor/generator as a power source.

The power delivery type of most hybrid vehicles under development is one of a series type or a parallel type. The series type has advantages in that the structure thereof is relatively simple compared to the parallel type and the control logic is also simple. However, in the series type, mechanical energy from an engine is stored in a battery and a vehicle is driven using a motor/generator, so there is a drawback of poor energy efficiency due to energy loss during energy conversions. On the other hand, the parallel type has drawbacks in that the structure and control logic are relatively complex, but the parallel type has an advantage of good energy efficiency because mechanical energy of an engine and electrical energy of a battery can be simultaneously and cooperatively used. For this reason, the parallel type is widely adopted in passenger cars of hybrid vehicles.

A problem of hybrid vehicles having either the series type or the parallel type is that energy circulation increases as a vehicle speed increases and thus an efficiency of a system is rapidly deteriorated. Various power delivery types aimed at solving the problem of energy circulation have been investigated, but none have been completely satisfactory.

### SUMMARY OF THE INVENTION

Embodiments of the present invention provide a power delivery system for hybrid vehicles having advantages of improving power delivery efficiency by changing the power delivery structure so as to prevent or reduce energy circulation and to allow the vehicle to drive at a high efficiency.

An exemplary embodiment of the present invention provides a power delivery system of a hybrid vehicle including: a planetary gear part disposed within a transaxle housing of the hybrid vehicle and including a first planetary gear, a second planetary gear and a third planetary gear; a driving motor/generator part including a first motor/generator connected to the third planetary gear such that power can be delivered therebetween when a hybrid vehicle starts so as to drive the hybrid vehicle, and a second motor/generator configured to deliver power to a driving shaft via the second planetary gear and supporting an engine so as to operate the driving shaft together with power generated by the engine in a hybrid mode; a clutch part connected to the planetary gear part such that the operation mode of hybrid vehicle can be changed at a critical mechanical point wherein mode conversion between a first compound-split mode and a second compound-split mode occurs; and a controller engaging or disengaging the first and second clutches of the clutch part depending on driving conditions of the hybrid vehicle to regulate mode conversion of the driving motor/generator part.

The first planetary gear may be directly connected to the engine so as to receive power generated by the engine.

The first motor/generator of the driving motor/generator part may be connected to a third carrier of the third planetary gear, and the second motor/generator may be connected to a second sun gear of the second planetary gear.

The clutch part may include: a first clutch connected to both the second planetary gear and the third planetary gear of the planetary gear part, and operating such that power generated by the engine and the first and second motor/generators can be delivered to a driving shaft; and a second clutch, one end of which is connected to the third planetary gear and the other end of which is connected to an inside of a transaxle housing, and operating to increase speed of the first motor/generator required for initial driving of the hybrid vehicle.

It may be configured such that braking and inertia energy generated in the hybrid vehicle is delivered to the first motor/generator or the second motor/generator via the planetary gear set while the hybrid vehicle runs at a regenerative braking mode of the first compound-split mode or the second compound-split mode.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic diagram showing a power delivery system of a hybrid vehicle according to an exemplary embodiment of the present invention;

FIG. 2 and FIG. 3 are schematic diagrams showing a power delivery system of a hybrid vehicle according to an exemplary embodiment of the present invention, operating respectively in the first compound-split mode and the second compound-split mode;

FIG. 4 is a plot showing an efficiency versus speed ratio of transmission of a power delivery system for a hybrid vehicle according to an exemplary embodiment of the present invention;

FIG. 5a and FIG. 5b are plots respectively showing the speed and the torque of a first motor/generator versus speed ratio of transmission of a power delivery system for a hybrid vehicle according to an exemplary embodiment of the present invention and

FIG. 6a and FIG. 6b are plots respectively showing the speed and the torque of a second motor/generator versus speed ratio of transmission of a power delivery system for a hybrid vehicle according to an exemplary embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE EMBODIMENTS

Reference will now be made in detail to various embodiments of the present inventions, examples of which are illustrated in the accompanying drawings and described below. While the inventions will be described in conjunction with exemplary embodiments, it will be understood that present description is not intended to limit the inventions to those exemplary embodiments. On the contrary, the inventions are intended to cover not only the exemplary embodiments, but also various alternatives, modifications, equivalents and other embodiments, which may be included within the spirit and scope of the invention as defined by the appended claims.

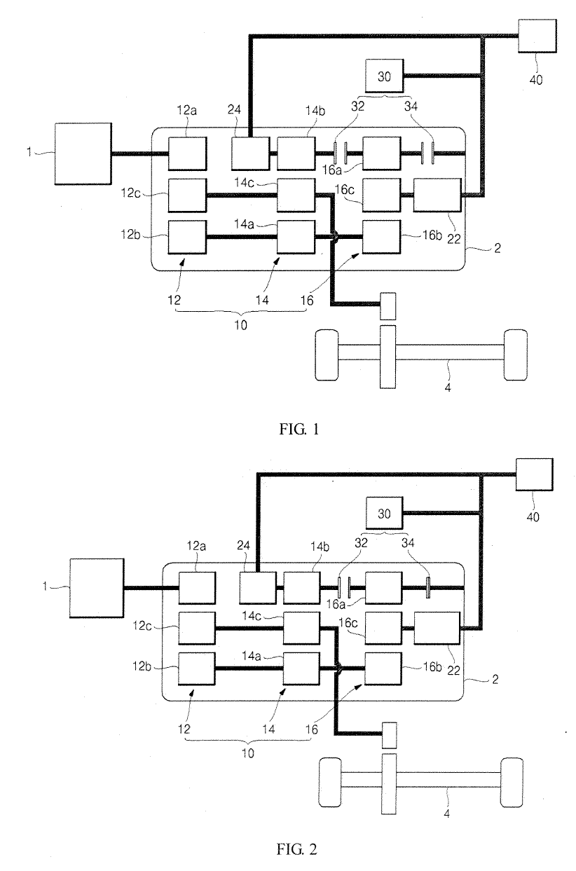

Referring to FIG. 1, a planetary gear part 10, which includes a first planetary gear 12, a second planetary gear 14 and a third planetary gear 16, is disposed within a transaxle housing 2. The first planetary gear 12 includes a first ring gear 12a, a first sun gear 12b and a first carrier 12c; the second planetary gear 14 includes a second ring gear 14a, a second sun gear 14b and a second carrier 14c; and the third planetary gear 16 includes a third ring gear 16a, a third sun gear 16b and a third carrier 16c. The first carrier 12c of the first planetary gear 12 is connected to the second carrier 14c of the second planetary gear 14 such that power can be delivered therebetween, and the first sun gear 12b is connected to the second ring gear 14a of the second planetary gear 14 such that power can be delivered therebetween.

The first planetary gear 12 is directly connected to an engine 1 so as to receive power generated by the engine 1. The first ring gear 12a is preferably connected to the engine 1. The second ring gear 14a of the second planetary gear 14 receives power from the first sun gear 12b, and is configured to be connected to the third sun gear 16b of the third planetary gear 16.

A driving motor/generator part comprises a first motor/generator 22 and second motor/generator 24. The first motor/generator 22 of the driving motor/generator part is connected to the third carrier 16c of the third planetary gear 16, and the second motor/generator 24 is connected to the second sun gear 14b of the second planetary gear 14. The first motor/generator 22 is connected to the third carrier 16c of the third planetary gear 16 such that power can be delivered therebetween.

The first motor/generator 22 of driving motor/generator part may receive power from a battery when a vehicle starts so as to drive the vehicle without power from the engine. The first motor/generator 22 and second motor/generator 24 may be incorporated to supply power to the vehicle so as to allow the vehicle to run only by electrical power when the vehicle starts or runs. The motor/generators 22 and 24 further may start the engine by sufficiently increasing speed of the engine while the vehicle runs and thus makes the engine operate with hybrid effect of the motor/generators 22 and 24 and the engine 1 cooperatively or selectively.

The first motor/generators 22 and/or the second motor/generators 24 are configured to generate or absorb power during regenerative braking mode so as to maintain equilibrium of the system and to store energy as much as possible during regenerative braking mode of the first or second compound-split modes as explained below in detail.

In the view of speed ratio of transmission, the hybrid vehicle is driven under the real-time mode conversion between the first and second compound-split modes, depending on the speed ratio of the transmission.

The compound-split mode comprises a first compound-split mode and a second compound-split mode. The first compound-split mode is the operation mode to perform the high efficiency of driving above the critical mechanical point of the hybrid vehicle and the second compound-split mode is the operation mode to perform the high efficiency below the critical mechanical point. Usually the first compound-split mode is performed at the low speed and the second compound-split mode is at the high speed.

Each compound-split mode has at least a mechanical point as shown in FIG. 4. The mechanical point is the point at which the mechanical power generated by the driving motor/generator part is zero. At the mechanical point, the efficiency defined as (the output power to the driving shaft) divided by (the engine power of the system) is 1 because the mechanical power of the engine is not transmitted to the driving motor/generator part at the mechanical point of the driving motor/generator part and thus all power of engine is transmitted mechanically through the planetary gear sets to the driving shaft 4. In defining the mechanical point, other loss is ignored for convenience as shown in FIG. 4. Since mechanical power is not present at the mechanical points in the driving motor/generator part, the system might provide a higher efficiency of operation by tracking the mechanical points, and thus a significant increase in performance can be realized.

However, the position of mechanical points depends on the speed ratio of the transmission as shown in FIG. 4. Since the dynamic features of driving motor/generator part is different according to the features of the speed ratio of the transmission, the dynamic features of driving motor/generator part must be considered. FIG. 4 shows a first mode including two mechanical points 110 and 120 at the low speed and a second mode not including mechanical points above the critical mechanical point 120 (i.e., right side). This plot demonstrates that under the first compound-split mode, the efficiency is increased via the first mode, not the second mode. However as the speed of vehicle is increased below the critical mechanical point 120 (i.e., left side), the first mode does not include mechanical point any more but the second mode includes two mechanical points 120 and 130. This demonstrates that under the second compound-split mode, the efficiency is increased via the second mode, not the first mode.

Accordingly, as shown in FIG. 4, for the exemplary embodiment of the present invention, two mechanical points 110 and 120 at the first compound-split mode and two mechanical points 120 and 130 at the second compound-split mode exist, and the mechanical point 120 is held in common by the first compound-split mode and the second split compound mode. For the increase of efficiency, mode conversion between the first and second compound-split modes might be preferable to be performed at this mechanical point, which is designated as a critical mechanical point in the present invention. That is, the critical mechanical point 120 is the point wherein the mode conversion between the first compound-split mode and the second compound-split mode occurs without loss of power, bringing high efficiency.

Therefore, the compound-split modes which includes the mechanical points 110, 120, and 130 has higher efficiency than the operation modes that does not convert the operation mode at the critical mechanical point (dotted line) as shown in FIG. 4.

In detail, referring to FIG. 4, the efficiency of the first mode is high at the low speed (i.e., above the speed ratio of about 0.7) but as the speed of vehicle becomes high, the efficiency of first mode becomes low as shown in FIG. 4. In contrast, the efficiency of the second mode is low at the low speed but as the speed of vehicle becomes high (i.e., below the speed ratio of about 0.7), the efficiency of second mode becomes high.

Therefore, at a critical mechanical point 120 in which the first compound-split mode and the second compound-split mode are overlapped in common, the mode conversion is preferable to increase the efficiency.

The mode conversion is performed by the operation of clutch part 30 controlled by the controller 40, as explained following.

The clutch part 30 includes a first clutch 32 connected to both the second planetary gear 14 and the third planetary gear 16 of the planetary gear part 10 and operates such that power generated by the engine 1 and the first and second motor/generators 22 and 24 can be selectively delivered to the driving shaft 4. The clutch part 30 further includes a second clutch 34, one end of which is connected to the third planetary gear 16 and the other end of which is connected to an inside of the transaxle housing 2. One end of the first clutch 32 is connected to the second sun gear 14b, and the other end thereof is connected to the third ring gear 16a. One end of the second clutch 34 is connected to the third ring gear 16a, and the other end thereof is connected to an inside of the transaxle housing 2. The second clutch 34 operates to increase speed of the first motor/generator 22 which is required for initial driving of a hybrid vehicle.

A controller 40 is provided to control the driving motor/generator part and the clutch part 30 according to driving conditions of the hybrid vehicle. Controller 40 may comprise a processor, memory and associated hardware and software as may be selected and programmed by persons of ordinary skill in the art based on the teachings of the present invention as set forth herein.

At an initial driving stage of a hybrid vehicle, the hybrid vehicle is driven only by the driving motor/generator part without using the engine 1. This is called a motor mode. At this stage, because the second motor motor/generator 22 does not make sufficient driving torque, the first clutch 32 is disengaged and the second clutch 34 is engaged so as to make the output of high speed ratio of transmission as shown in FIG. 2. In the viewpoint of the speed ratio, the motor mode might be classified as a first compound-split mode because of the low speed of motor mode (i.e., above the speed ratio of about 0.7).

After the motor mode, the hybrid vehicle performs a hybrid mode wherein the engine 1, the first motor/generator 24 and the second motor/generator 22, are operated or an engine mode wherein the first motor/generator 24 and the second motor/generator 22, are not operated. Accordingly the hybrid mode and/or the engine mode utilize the engine 1 but difference between the hybrid mode and the engine mode is determined based on power assistance of the battery. An engine mode is a mode in which power of the battery is not used, i.e. only the engine 1 drives the driving shaft 4.

However until the vehicle reaches the hybrid mode or engine mode, the speed of the engine 1 should be accelerated higher than an idle speed, and at this time, the speed of the engine 1 is increased by controlling the speed of the second motor/generator 24. If the speed of the engine 1 reaches a sufficient speed, the hybrid vehicle performs the hybrid mode or an engine mode selectively.

In the hybrid mode, the first motor/generator 24 and/or the second motor/generator 22 incorporates the engine 1 so as to supplement power of the engine 1 and to serve as a continuously-variable transmission. In the view of speed, the hybrid mode might be operated in the first compound-split mode or the second compound-split mode, depending on the speed ratio of transmission.

The controller may selectably control the mode conversion of the motor mode, the hybrid mode, the engine mode, and the regenerative braking mode, depending on the speed ratio of transmission and instruction signal of the driver.

Operating states for a power delivery system of a hybrid vehicle according to an exemplary embodiment of the present invention will be explained in detail hereinafter.

As explained above, the hybrid mode may have at least two compound-split modes, i.e., the first and second compound-split modes. The first compound-split mode includes the first mode having two mechanical points 110 and 120 and the second compound-split mode comprises the second mode having two mechanical points 120 and 130. The first mode is the mode to operate optimally the hybrid vehicle at the low speed and thus includes at least two mechanical points. The second mode is the mode to operate optimally the hybrid vehicle at the high speed and thus includes at least two mechanical points. The mechanical point 120 is overlapped between the first and second compound-split modes.

FIG. 2 is a schematic diagram showing states in which power delivery system of a hybrid vehicle operates in a first compound-split mode at a low speed (i.e., above the speed ratio of about 0.7) according to an exemplary embodiment of the present invention.

In detail, under the first compound-split mode, i.e., at the low speed (over the speed ratio of about 0.7), the vehicle runs at the first mode since efficiency of the first mode is higher than the second mode as shown in FIG. 4 which shows the efficiency of the hybrid vehicle in conjunction with the compound-split modes at the wide rage of speed ratio of transmission. The X axis (horizontal axis) represents a speed ratio, and the Y axis (vertical axis) represents an efficiency of a system.

The first compound-split mode may include the motor mode and hybrid mode, depending on the shift ratio of transmission.

As shown in FIG. 2, in the first compound-split mode, the first clutch 32 is released and the second clutch 34 is maintained to be coupled, so that speed of the first motor/generator 22 is increased and is connected to the third planetary gear 16.

At the regenerative braking mode of first compound-split mode, the controller 40 controls the speed and the torque of the driving motor/generator part such that the regenerative efficiency of the system can be enhanced according to driving conditions. When regenerative braking is performed at the low speed, i.e., over the speed ratio of about 0.7, the speed of the engine 1 is controlled at zero so as to reduce power consumption by the engine 1 as much as possible. The second motor/generator 24 generates braking power so that equilibrium of the system is maintained and the vehicle is braked.

At this time, power of driving shaft 4 is preferably transmitted to the first motor/generator 22 via the third planetary gear 16 and thus the first motor/generator 22 absorbs power. The battery (not shown) is charged with energy generated in this process. Accordingly, energy generated by the speed decrease of a hybrid vehicle is converted into electrical energy and is then stored. The stored energy is used in the motor mode or when operation of the driving motor/generator part is required.

The efficiency of the first compound-split mode is demonstrated in FIG. 4. As explained above, the first compound-split mode having a high efficiency at low speed i.e., a high shift ratio has two mechanical points 110 and 120. Accordingly, over the shift ratio of about 0.7, in order to enhance efficiency of the system, it is preferable to perform the first mode comprising mechanical points 110 and 120 at this exemplary embodiment. The mechanical points 110 and 130 have about 1.7 and 0.4 of speed ratio in the present illustrative embodiment.

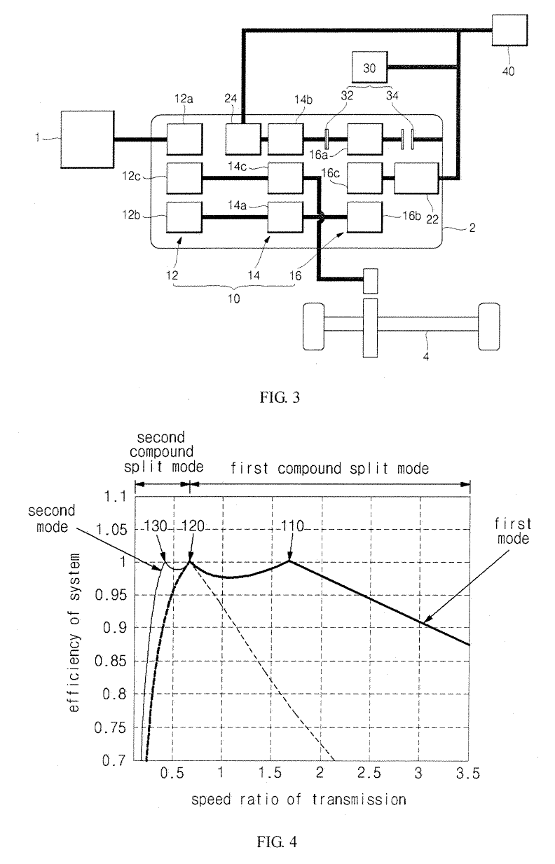

FIG. 3 is a structural diagram showing the second compound-split mode in which a power delivery system of a hybrid vehicle below the shift ratio of about 0.7 is demonstrated according to an exemplary embodiment of the present invention.

In the second compound-split mode, the first clutch 32 is controlled to be coupled and the second clutch 34 is controlled to be released by the controller 40. Both the second planetary gear set 14 and the third planetary gear 16 are operated since the first clutch 32 is coupled. The first planetary gear 12 is driven by the second motor/generator 24 and the engine 1. Accordingly, all of three planetary gear sets 12, 14, and 16 of the planetary gear part 10 operate. Since the clutch part 3 are released and coupled substantially at the same time, transient characteristics of the system can be reduced on the mode conversion.

Referring to FIG. 4 again, the second compound-split mode having a high efficiency at high speed i.e., below a speed ratio of about 0.7 in this exemplary embodiment is shown. The second compound-split mode has two mechanical points 120 and 130 on the second mode. Therefore, in order to enhance efficiency of the system, it is preferable to perform the second mode including said mechanical points 120 and 130 wherein the mechanical power is zero.

Accordingly, since the efficiency of the system can be enhanced when a vehicle runs at the mechanical points 110, 120 and 130, the controller 40 controls the first motor/generator 22 and the second motor/generator 24 to change the operation mode at the critical mechanical point 120 which is transient point between the first compound-split mode and the second compound-split mode.

The regenerative braking of the second compound-split mode is performed when braking force is operated while the vehicle runs at a high speed, i.e., below the shift ratio of about 0.7 in this exemplary embodiment. For the regenerative braking of the second compound-split mode, the controller maintains the speed of the engine 1 at zero and the first motor/generator 22 generates power and the second motor/generator 24 mainly absorbs the regenerative braking energy in an exemplary embodiment and transmits the same to the battery.

The controller 40 controls the speed and the torque of the driving motor/generator part such that the regenerative efficiency of the system can be enhanced according to driving conditions. The battery (not shown) is charged with energy generated in this process. Accordingly, energy generated by the speed decrease of a hybrid vehicle is converted into electrical energy and is then stored in the battery. The stored energy is used when operation of the driving motor/generator part is required.

More explanation on mode conversion for the motor / generators 22 and 24 of the driving motor/generator part is followed next.

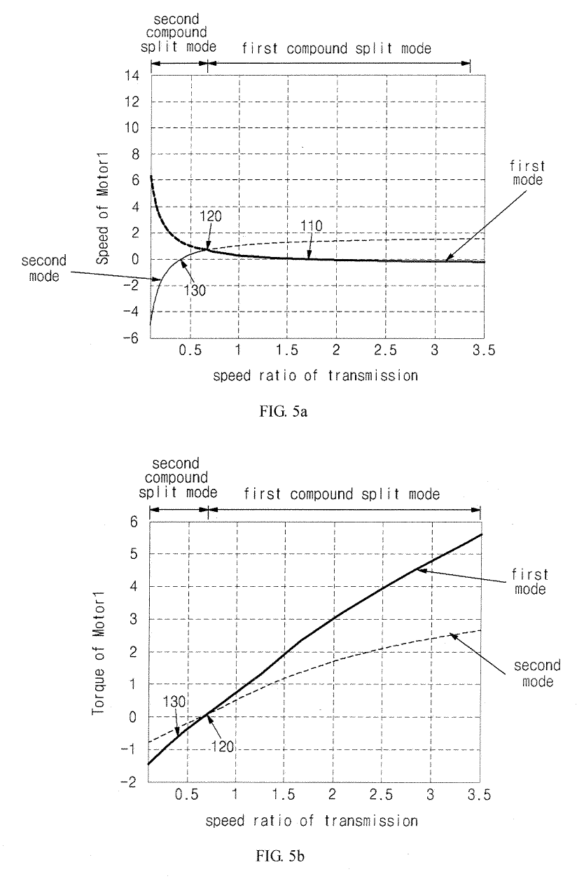

Referring to FIGS. 5a and 5b, the X axis (horizontal axis) of FIG. 5a represents a speed ratio of transmission and a Y axis (vertical axis) represents a speed of the first motor/generator 22. The X axis (horizontal axis) of FIG. 5b represents a speed ratio of transmission, and the Y axis (vertical axis) represents torque of the first motor/generator 22. The intersecting point 120 of the first mode and the second mode represents a critical mechanical point of the first compound-split mode.

At the first compound-split mode (over the speed ratio of about 0.7), the mechanical power of the hybrid vehicle calculated by multiplying the speed (referring to FIG. 5a) with the torque (referring to FIG. 5b) of the first motor/generator 22, represented by the first mode, is lower than the second mode that does not have the mechanical points. The first compound-split mode, hence, reduces power loss and amount of energy circulation at the motor/generator part and thus improves the efficiency of the system.

In contrast, at the high speed at which a vehicle runs below the speed ratio of about 0.7 of transmission, the first mode is not effective because it increase the mechanical power of the driving motor/generator part as shown in FIG. 5a and 5b. Therefore the second compound-split mode which performs the second mode is preferable because the mechanical power of the second mode includes the mechanical points 120 and 130 wherein the mechanical power is zero. Furthermore, the volume and size of the first motor/generator 22 is reduced because the required torques of first motor/generator 22 is decreased as shown in FIG. 5b

Referring to FIG. 5b, like FIG. 5a, mode conversion between the first compound-split mode and the second compound-split mode is performed at the critical mechanical point 120.

Mode conversion for the second motor/generator 24 of the driving motor/generator part is explained hereinafter.

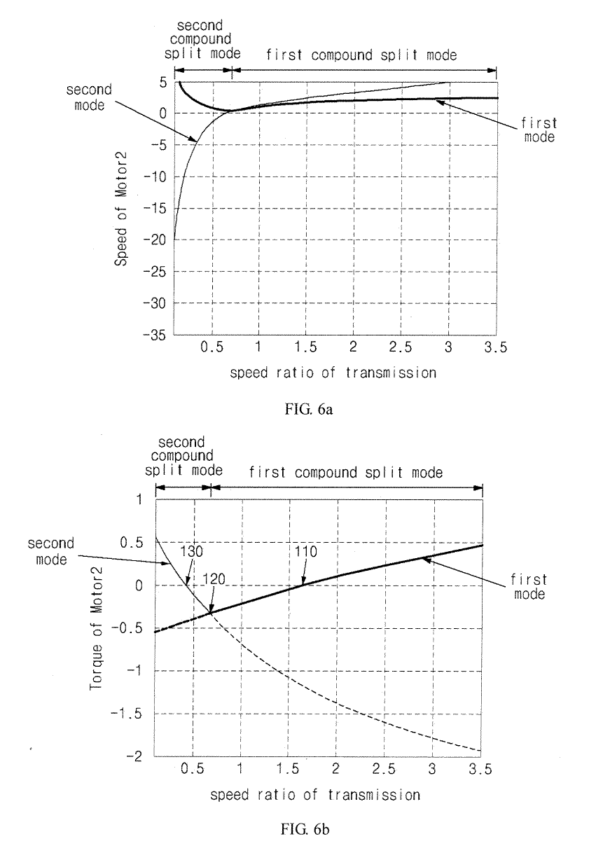

Referring to FIGS. 6a and 6b, the X axis (horizontal axis) of FIG. 6a represents a speed ratio of transmission and a Y axis (vertical axis) represents speed of the second motor/generator 24. The X axis (horizontal axis) of FIG. 6b represents a speed ratio of transmission, and the Y axis (vertical axis) represents torque of the second motor/generator 24. The intersecting point 120 of the first compound-split mode and the second compound-split mode represents a critical mechanical point.

Explanations for FIG. 6a and FIG. 6b are similar to those of FIG. 5a and FIG. 5b. That is, if the hybrid vehicle continuously runs without a mode conversion at the critical mechanical point 120, mechanical power of the second motor/generator 24 continuously increases with the increase of the speed ratio of the transmission and thus the efficiency decreases. Furthermore, the volume and size of the second motor/generator 24 is reduced because the required torques of first motor/generator 24 is decreased as shown in FIG. 6b

However, since the mechanical power of the second motor/generator 24 is decreased by performing mode conversion at the critical mechanical point 120 between the first compound-split mode and the second compound-split mode, the mechanical power and the amount of power circulation at the second motor/generator 24 is decreased.

Torque and speed, which are covered by the first motor/generator 22 and the second motor/generator 24 are determined by the structure of the planetary gear part 10. This is related to the positions of the mechanical points of the respective compound-split modes. Accordingly, it is preferable to configure the planetary gear 10 by suitably setting respective gear ratios of the planetary gear part 10 such that the system may have high efficiency at wide shift speed ratio range and the respective motor/generators 22 and 24 may operate at points where operating speed and torque are as small as possible.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

As described above, a power delivery system of a hybrid vehicle according to the present invention can operate at an excellent efficiency in all speed ratio region, and can obtain a wider speed range while a vehicle runs at a hybrid mode than a conventional power delivery system.

What is claimed is:

1. A power delivery system of a hybrid vehicle, comprising:
a planetary gear part disposed within a transaxle housing of the hybrid vehicle and including a first planetary gear, a second planetary gear, and a third planetary gear;
a driving motor/generator part including a first motor/generator connected to the third planetary gear such that power is delivered therebetween, and a second motor/generator configured to deliver power to a driving shaft via the second planetary gear so as to operate the driving shaft together with power generated by the engine;
a clutch part connected to the planetary gear part such that the hybrid vehicle can drive by changing an operation mode of a transmission at at least a critical mechanical point wherein a mode conversion between a first compound-split mode and a second compound-split mode occurs; and
a controller controlling the operation mode of the driving motor/generator part and the clutch part depending on the operation mode of the hybrid vehicle.

2. The power delivery system of claim 1, wherein the first planetary gear is connected to the engine so as to receive power generated by the engine.

3. The power delivery system of claim 1, wherein the first motor/generator of the driving motor/generator part is connected to a third carrier of the third planetary gear, and the second motor/generator is connected to a second sun gear of the second planetary gear.

4. The power delivery system of claim 1, wherein the clutch part comprises:
a first clutch connected to both the second planetary gear and the third planetary gear of the planetary gear part, and operating such that power generated by the engine and the first and the second motor/generators can be delivered to a driving shaft; and
a second clutch one end of which is connected to the third planetary gear and the other end of which is connected to an inside of the transaxle housing, and operating to increase torque of the first motor/generator required for initial driving of the hybrid vehicle.

5. The power delivery system of claim I, wherein braking and inertia energy generated in the hybrid vehicle is delivered to the first motor/generator via the second planetary gear while the hybrid vehicle runs at a regenerative braking mode of the first compound-split mode.

6. The power delivery system of claim 1, wherein braking and inertia energy generated in the hybrid vehicle is delivered to the second motor/generator via the second planetary gear while the hybrid vehicle runs at a regenerative braking mode of the second compound-split mode.
